(19) United States
(12) Patent Application Publication
(10) Pub. No.: US 2009/0063264 A1
(43) Pub. Date: Mar. 5, 2009

(54) METHOD FOR TRANSMITTING ONLINE ADVERTISEMENTS TO USERS

(75) Inventor: Alan Leung, Hong Kong (HK)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Patronsoft Limited, Hong Kong (HK)

(21) Appl. No.: 11/849,630

(22) Filed: Sep. 4, 2007

(51) Int. Cl. G06Q 30/00

(52) U.S. Cl. 705/14

(57) ABSTRACT

A method for transmitting online advertisements 52 to users 40, the method being implemented at an Internet gateway device 20, the method comprising: searching for keywords identified 51 by an advertiser, the keywords 51 being present in a web page 50 requested by a user 40 accessing the Internet via the Internet gateway device 20; modifying the web page 50 by replacing the keywords 51 with a hypertext link 52 provided by the advertiser; and delivering the modified web page 50 to the user; wherein the advertisements 52 are transmitted to users 40 in exchange for access of the Internet via the Internet gateway device 20 for free or at a discounted price.

### TECHNICAL FIELD

The invention concerns a method for transmitting online advertisements to users that is implemented at an Internet gateway device.

### BACKGROUND OF THE INVENTION

The online advertising market has grown exponentially in recent years due to the broad usage of the Internet. Typically, online advertising is provided as banner advertisements on web pages, an intermission web page which requires the user to click, or inline advertisements in articles. Advertising fees are paid to the web site owner based on the number of clicks, visitors to the page or a combination of both.

Even though Internet access at the home and the office is available for most people, there are some people who use an Internet café to access the Internet. Also, in some public venues such as restaurants, cafes and airports, Internet access is desirable. Usually, Internet access requires payment of a fee in exchange for access time. Alternatively, free Internet access is provided to attract customers to a particular venue. The cost of providing access is subsidized or recouped by the venue through other means, for example, sales or purchases at a restaurant or café. However, this business model requires the café or restaurant to recover the money directly and to manage the Internet access. This is in efficient as it may not be their core competency or their primary business activity.

Therefore, there is a desire to provide Internet access without requiring direct payment from the user for access, and does not place administrative burden on businesses to recover the associated costs with providing Internet access to their customers.

### SUMMARY OF THE INVENTION

In a first preferred aspect, there is provided a method for transmitting online advertisements to users, the method being implemented at an Internet gateway device, the method comprising:
searching for keywords identified by an advertiser, the keywords being present in a web page requested by a user accessing the Internet via the Internet gateway device;
modifying the web page by replacing the keywords with a hypertext link provided by the advertiser; and
delivering the modified web page to the user;
wherein the advertisements are transmitted to users in exchange for access of the Internet via the Internet gateway device for free or at a discounted price.

The method may further comprise promoting or highlighting or enlarging the identified keywords relative to the surrounding text

The method may further comprise creating a mouse-over annotation overlay for the identified keywords, wherein an annotation is overlaid on the web page when the user places their mouse cursor over an identified keyword.

The annotation may contain a disclaimer and information about the advertiser including contact details and current promotions or sales.

The Internet gateway device may be a network router to connect the users to the Internet.

In a second aspect, there is provided a system for transmitting online advertisements to users, the system comprising:
a keyword searching module to search for keywords identified by an advertiser, the keywords being present in a web page requested by a user accessing the Internet via the Internet gateway device;
a keyword replacing module to modify the web page by replacing the keywords with a hypertext link provided by the advertiser; and
delivering the modified web page to the user;
wherein the advertisements are transmitted to users in exchange for access of the Internet via the Internet gateway device for free or at a discounted price.

The system may further comprise an advertisement store to store details of advertisement associated with the identified keywords.

### BRIEF DESCRIPTION OF THE DRAWINGS

An example of the invention will now be described with reference to the accompanying drawings, in which:

FIG. 1 is a screenshot of a web page having certain keywords replaced with advertising in accordance with a preferred embodiment of the present invention; and

FIG. 2 is a block diagram of the advertising system in accordance with a preferred embodiment of the present invention.

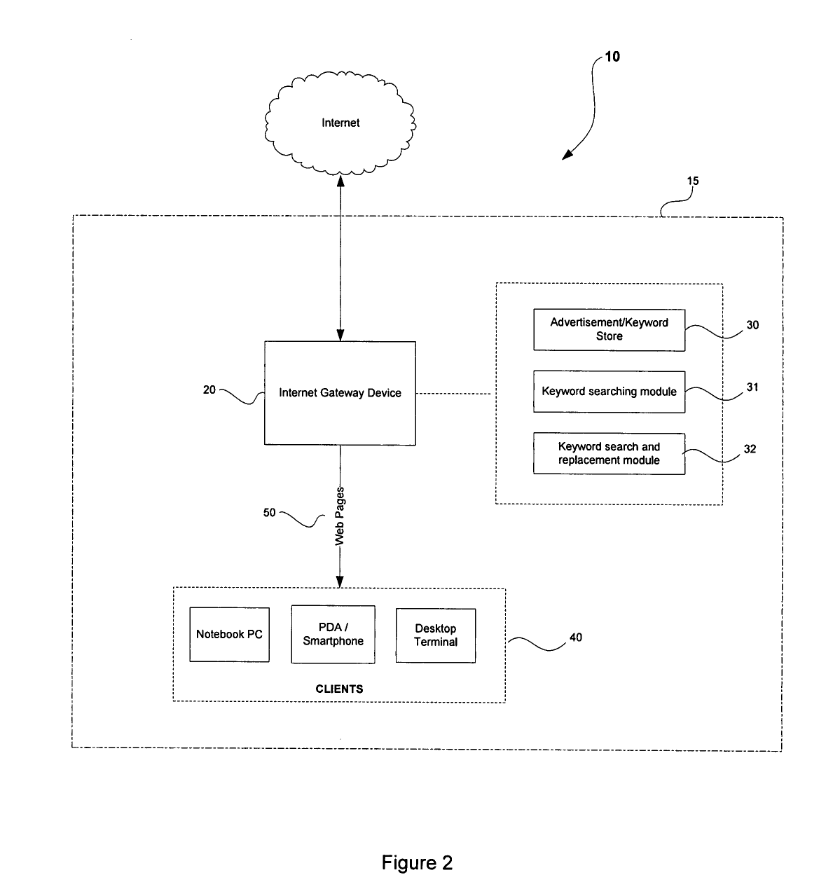

### DETAILED DESCRIPTION OF THE DRAWINGS

Referring to the drawings, a system 10 for transmitting online advertisements to users 40 is provided. The system 10 generally comprises: a keyword searching module 31 and a keyword replacing module 32. The keyword searching module 31 searches for keywords 51 identified by an advertiser. The keywords 51 are present in a web page 50 requested by a user 40 accessing the Internet via an Internet gateway device 20. The Internet gateway device 20 is a network router to connect the users 40 to the Internet. The keyword replacing module 32 modifies the web page 50 by replacing the keywords 51 with a hypertext link 52 provided by the advertiser. The modified web page 50 is delivered to the user 40. The advertisements are transmitted to users 40 in exchange for access of the Internet via the Internet gateway device 20 for free or at a discounted price.

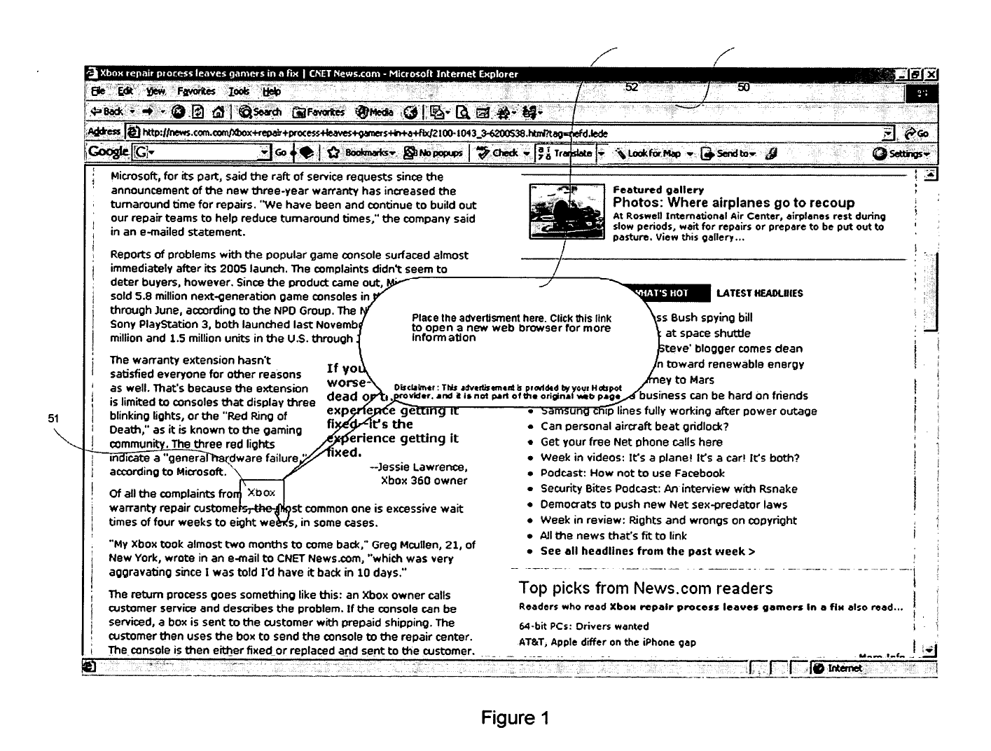

Turning to FIG. 1, the identified keywords 51 may be promoted or highlighted or enlarged relative to the surrounding text. A mouse-over annotation overlay 52 for the identified keywords 51 is created. An annotation overlay 52 is overlaid on the web page 50 when the user 40 places their mouse cursor over an identified keyword 51. The annotation overlay 52 contains a disclaimer and information about the advertiser including hypertext link, contact details and current promotions or sales.

Advertisements and details of advertisement associated with the identified keywords 51 are stored in an advertisement store 30. The advertisement store 30 is a repository of advertisements and enables advertisers to manage their account and payment details, select and buy keywords 51 for advertisement purposes.

The process for modifying the requested web page 50 is described. For all HTTP request packets initiated from the client 40, the destination IP address is changed to the local IP address and the destination port is changed to a predetermined port. The TCP checksum is recalculated because the destination IP address and destination port are changed. A service to listen to this predetermined port is started.

This service keeps listening for “redirected” HTTP requests on the predetermined port. Once a “redirected” HTTP request is detected, the “Accept-Encoding” parameter is made empty. In example 1 below, the “gzip, deflate” is removed so that the reply is not encoded. Then, the web page 50 is requested on behalf of the client. When the HTTP reply is returned from the web site, the HTML content is modified in order to create the mouse-over annotation overlay 52 on the keywords 51. Since the HTML content is modified, the “Content-Length” parameter is refreshed within the HTTP header to reflect the new length of the HTML content. In example 2 below, 75781 is refreshed. If the HTML is “chunked”, the chunk size is also refreshed. In example 3, 621 is refreshed.

The modified web page is sent to the client 40. The source IP address and source port are changed back to the original source IP address and source port so that the client 40 continues to communicate with the original requested site. This is necessary as the TCP/IP stack of the client 40 will only expect a result from the original requested site's IP address and port. Also, the TCP checksum is recalculated again but the source IP address and source port is changed instead.

The client is able to receive the modified web page 50 without error.

### EXAMPLE 1

### GET/HTTP/1.1

Accept: image/gif, image/x-xbitmap, image/jpeg, image/pjpeg, application/x-shockwave-flash, application/vnd.ms-powerpoint, application/vnd.ms-excel, application/msword, */*
Accept-Language: en-us
Accept-Encoding: gzip, deflate
User-Agent: Mozilla/4.0 (compatible; MSIE 6.0; Windows NT 5.1; SV1; .NET CLR 2.0.50727)

### Host: www.cnn.com

### Connection: Keep-Alive

Cookie: SelectedEdition=www; CNNid=Ga50aac79-21586-1187841321-595; s_pers=%20s_lastvisit%3D1188214705343%7C1282822705343%3B%20s_vnum%3D1190433326484%2526vn%253D10%7C1190433326484%3B%20s_invisit%3Dtrue%7C1188216505359%3B; s_vi=[CS]v1|46CD052D00007A43-A170C4400000A97[CE]; adDEmas=R02&hi&covatta.net&0&hkg&-1&0&7310&-&-&-&; adDEon=true

### EXAMPLE 2

### HTTP/1.1 200 OK

### Date: Thu, 12 Jul. 2007 04:09:49 GMT

### Server: Apache/1.3.31 (Unix)

### Last-Modified: Thu, 12 Jul. 2007 04:01:13 GMT

ETag: “6b63f-12805-4695a789”
Accept-Ranges: bytes

### Content-Length: 75781

Keep-Alive: timeout=5

### Connection: Keep-Alive

Content-Type: text/html

### EXAMPLE 3

### HTTP/1.1 200 OK

### Server: Netscape-Enterprise/6.1 AOL

### Date: Thu, 12 Jul. 2007 10:20:14 GMT

Set-cookie: CurrentEdition=edition; domain=.cnn.com; path=/; expires=Thursday, 12 Jul. 2007 11:21:02 GMT;

### Last-modified: Thu, 12 Jul. 2007 10:21:02 GMT

### Expires: Thu, 12 Jul. 2007 10:22:02 GMT

Cache-control: private, max-age=60
Content-type: text/html
Transfer-Encoding: chunked
621

### <!DOCTYPE HTML PUBLIC “-//W3C//DTD HTML 4.01 Transitional//EN”

“http://www.w3.org/TR/html4/loose.dtd”> <html lang=“en”> <head> <title>CNN.com International</title>.<meta http-equiv=“content-type” content=“text/html; charset=iso-8859-1”>
<meta http-equiv=“refresh” content=“1800”>
<link rel=“alternate” type=“application/rss+xml” title=“CNN—Top Stories [RSS]” href=“http://rss.cnn.com/rss/edition.rss”>
<link rel=“alternate” type=“application/rss+xml” title=“CNN—Recent Stories [RSS]” href=“http://rss.cnn.com/rss/cnn_latest.rss”>
<style type=“text/css” media=“screen”>
@import url (http://i.l.cnn.net/cnn/.element/css/2.0/common.css);
@import url (http://i.l.cnn.net/cnn/.element/css/2.0/main.css);
@import url (http://i.l.cnn.net/cnn/.element/css/2.0/main-intl.css);
</style>

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed:

1. A method for transmitting online advertisements to users, the method being implemented at an Internet gateway device, the method comprising:
searching for keywords identified by an advertiser, the keywords being present in a web page requested by a user accessing the Internet via the Internet gateway device;
modifying the web page by replacing the keywords with a hypertext link provided by the advertiser; and
delivering the modified web page to the user;
wherein the advertisements are transmitted to users in exchange for access of the Internet via the Internet gateway device for free or at a discounted price.

2. The method according to claim 1, further comprising promoting or highlighting or enlarging the identified keywords relative to the surrounding text

3. The method according to claim 1, further comprising creating a mouse-over annotation overlay for the identified keywords, wherein an annotation is overlaid on the web page when the user places their mouse cursor over an identified keyword.

4. The method according to claim 3, wherein the annotation contains a disclaimer and information about the advertiser including contact details and current promotions or sales.

5. The method according to claim 1, further comprising:
creating a redirected HTTP request by changing the destination IP address and destination port of a HTTP request packet initiated by the user when requesting the web page to a local IP address and predetermined port;
re-calculating the TCP checksum;
starting a service to listen to the predetermined port for redirected HTTP requests;
wherein if the service detects a redirected HTTP request:
setting the Accept-Encoding parameter to empty;
requesting the web page on behalf of the user;
modifying the HTML content by replacing the keywords with the hypertext link provided by the advertiser;
refreshing the Content-Length parameter;
changing the source IP address and predetermined port to the original IP address and original port; and
re-calculating the TCP checksum.

6. The method according to claim 5, wherein if the HTML content is chunked, the chunk size is refreshed.

7. The method according to claim 1, wherein the Internet gateway device is a network router to connect the users to the Internet.

8. A system for transmitting online advertisements to users, the system comprising:
a keyword searching module to search for keywords identified by an advertiser, the keywords being present in a web page requested by a user accessing the Internet via the Internet gateway device;
a keyword replacing module to modify the web page by replacing the keywords with a hypertext link provided by the advertiser; and
delivering the modified web page to the user;
wherein the advertisements are transmitted to users in exchange for access of the
Internet via the Internet gateway device for free or at a discounted price.

9. The system according to claim 8, further comprising an advertisement store to store details of advertisement associated with the identified keywords.
